(19) United States
(12) Patent Application Publication
(10) Pub. No.: US 2010/0305792 A1
(43) Pub. Date: Dec. 2, 2010

(54) Dynamically Reconfigurable High Power Energy Storage for Hybrid Vehicles

(75) Inventors: Michael D. Wilk, Temecula, CA (US); David M. Mazaika, San Diego, CA (US)

Correspondence Address: PROCOPIO, CORY, HARGREAVES & SAVITCH LLP, 525 B STREET, SUITE 2200, SAN DIEGO, CA, 92101, US

(73) Assignee: ISE CORPORATION, Poway, CA (US)

(21) Appl. No.: 12/475,290

(22) Filed: May 29, 2009

(51) Int. Cl. G06F 19/00

(52) U.S. Cl. 701/22

(57) ABSTRACT

A system for dynamically reconfiguring high power energy storage of a hybrid electric vehicle is described. The system includes a fault detector, a switch network and a controller. The fault detector is configured to detect a fault condition of one or more energy storage modules of the vehicle energy storage. The switch network is configured to electrically bypass one or more faulty energy storage modules. The controller is configured to determine a faulty energy storage module. The controller determines that current flow between the vehicle energy storage and the hybrid electric vehicle is below a minimum threshold and reconfigures operation controls to operate the vehicle energy storage according to a second configuration that accounts for the electrically bypassed faulty energy storage module. The controller also resumes operation of the vehicle energy storage according to the second configuration.

### FIELD OF THE INVENTION

This invention relates to hybrid electric vehicles and high power electric drive systems. In particular, the invention relates to systems and methods for dynamically reconfiguring a high power propulsion energy storage of a hybrid electric vehicle.

### BACKGROUND OF THE INVENTION

A hybrid electric vehicle (HEV) is a vehicle which combines a conventional propulsion system with an on-board rechargeable energy storage system to achieve better fuel economy and cleaner emissions than a conventional vehicle. While HEVs are commonly associated with automobiles, heavy-duty hybrids also exist. In the U.S., a heavy-duty vehicle is legally defined as having a gross weight of over 8,500 lbs. A heavy-duty HEV will typically have a gross weight of over 10,000 lbs., and may include vehicles such as a metropolitan transit bus, a refuse collection truck, a semi tractor trailer, etc.

In a parallel configuration (not shown), an HEV will commonly use an internal combustion engine (ICE) provide mechanical power to the drive wheels, and to generate electrical energy. The electrical energy is stored in an energy storage device, such as a battery pack or an ultracapacitor pack, and may be used to assist the drive wheels as needed, for example during acceleration.

Referring to FIG. 1, in a series configuration, an HEV drive system 100 will commonly use an energy generation source such as a fuel cell (not shown) or an “engine genset” 110 comprising an engine 112 (e.g., ICE, H-ICE, CNG, LNG, etc.) coupled to a generator 114, and an energy storage pack 120 (e.g., battery, ultracapacitor, flywheel, etc.) to provide electric propulsion power to its drive wheel propulsion assembly 130. In particular, the engine 112 (here illustrated as an ICE) will drive generator 114, which will generate electricity to power one or more electric propulsion motor(s) 134 and/or charge the energy storage 120. Energy storage 120 may solely power the one or more electric propulsion motor(s) 134 or may augment electric power provided by the engine genset 110. Multiple electric propulsion motor(s) 134 may be mechanically coupled via a combining gearbox 133 to provide increased aggregate torque to the drive wheel assembly 132 or increased reliability. Heavy-duty HEVs may operate off a high voltage electrical power system rated at over 500 VDC. Propulsion motor(s) 134 for heavy-duty vehicles (here, having a gross weight of over 10,000) may include two AC induction motors that each produces 85 kW of power and having a rated DC voltage of 650 VDC.

Unlike lower rated systems, heavy-duty high power HEV drive system components may also generate substantial amounts of heat. Due to the high temperatures generated, high power electronic components such as the generator 114 and electric propulsion motor(s) 134 will typically be cooled (e.g., water-glycol cooled), and may also be included in the same cooling loop as the ICE 112.

Since the HEV drive system 100 may include multiple energy sources (i.e., engine genset 110, energy storage device 120, and drive wheel propulsion assembly 130 in regen—discussed below), in order to freely communicate power, these energy sources may then be electrically coupled to a power bus, in particular, a DC high power bus 150. In this way, energy can be transferred between components of the high power hybrid drive system as needed.

An HEV may further include both AC and DC high power systems. For example, the drive system 100 may generate, and run on, high power AC, but it may also convert it to DC for storage and/or transfer between components across the DC high power bus 150. Accordingly, the current may be converted via an inverter/rectifier 116, 136 or other suitable device (hereinafter “inverters” or “AC-DC converters”). Inverters 116, 136 for heavy-duty vehicles (i.e., having a gross weight of over 10,000) are costly, specialized components, which may include a special high frequency (e.g., 2-10 kHz) IGBT multiple phase water-glycol cooled inverter with a rated DC voltage of 650 VDC and having a rated peak current of 300 A.

As illustrated, HEV drive system 100 includes a first inverter 116 interspersed between the generator 114 and the DC high power bus 150, and a second inverter 136 interspersed between the generator 134 and the DC high power bus 150. Here the inverters 116, 136 are shown as separate devices, however it is understood that their functionality can be incorporated into a single unit.

As a key added feature of HEV efficiency, many HEVs recapture the kinetic energy of the vehicle via regenerative braking, rather than dissipating kinetic energy via friction braking. In particular, regenerative braking (“regen”) is where the electric propulsion motor(s) 134 are switched to operate as generators, and a reverse torque is applied to the drive wheel assembly 132. In this process, the vehicle is slowed down by the main drive motor(s) 134, which converts the vehicle's kinetic energy to electrical energy. As the vehicle transfers its kinetic energy to the motor(s) 134, now operating as a generator(s), the vehicle slows and electricity is generated and stored. When the vehicle needs this stored energy for acceleration or other power needs, it is released by the energy storage 120. This is particularly valuable for vehicles whose drive cycles include a significant amount of stopping and acceleration (e.g., metropolitan transit buses). Regenerative braking may also incorporated into an all-electric vehicle (EV) thereby providing a source of electricity generation onboard the vehicle.

HEV drive system 100 may also include braking resistor 140. When the energy storage 120 reaches a predetermined capacity (e.g., fully charged), the drive wheel propulsion assembly 130 may continue to operate in regen for efficient braking. However, instead of storing the energy generated, any additional regenerated electricity may be dissipated through a resistive braking resistor 140. Typically, the braking resistor 140 will be included in the cooling loop of the ICE 112, and will dissipate the excess energy as heat.

Focusing on the vehicle's energy storage, the energy storage pack 120 may be made up of a plurality of energy storage cells 122. Increasing the number of cells in the pack 120 will increase the pack's capacity. The plurality of energy storage cells 122 may be electrically coupled in series, increasing the packs voltage. Alternately, energy storage cells 122 may be electrically coupled in parallel, increasing the packs current, or both in series and parallel.

When an energy storage cell (e.g., an ultracapacitor) is faulty, deteriorated, or damaged it may have an increased equivalent series resistance (ESR). In this situation, if the pack continues to deliver/receive the same current, the voltage across the failed ultracapacitor will increase. This increased voltage may cause further deterioration and lead to poor performance and increased ESR across the bad cell. Ultimately the cell may fail all together. A complete failure may then lead to the loss of the entire energy storage pack and/or catastrophic loss to the vehicle.

Thus what is needed is a technique for efficiently responding to an isolated failure in an energy storage system of the hybrid electric vehicle.

### SUMMARY

The present invention includes a system and a method for dynamically reconfiguring high power energy storage of a hybrid electric vehicle or an electric vehicle. In one embodiment, a system adapted to dynamically reconfigure a vehicle energy storage of a hybrid electric vehicle is described. The vehicle energy storage includes one or more energy storage modules, each having a plurality of energy storage cells, where the vehicle energy storage stores vehicle propulsion energy. The hybrid electric vehicle is configured to operate the vehicle energy storage according to a first configuration.

The system includes a fault detector, a switch network and a controller. The fault detector is configured to detect a fault condition of one or more energy storage modules of the vehicle energy storage. The switch network is configured to electrically bypass one or more faulty energy storage modules. The controller is configured to determine and bypass the faulty energy storage module, and to reconfigure the vehicle and/or system.

Before bypassing the faulty energy storage module, the controller first determines that current flow between the vehicle energy storage and the hybrid electric vehicle is below a minimum threshold. The controller also reconfigures operation controls to operate the vehicle energy storage according to a second configuration that accounts for the electrically bypassed faulty energy storage module. The controller then resumes operation of the vehicle energy storage according to the second configuration.

In another embodiment, a method adapted to dynamically reconfigure a vehicle energy storage of a hybrid electric vehicle is described. The vehicle energy storage includes one or more energy storage modules, each having a plurality of energy storage cells, where the vehicle energy storage stores vehicle propulsion energy. The method includes operating the vehicle energy storage according to a first configuration. The method also includes detecting a faulty energy storage module of the one or more energy storage modules and determining that current flow between the vehicle energy storage and the hybrid electric vehicle is below a minimum threshold. Further, the method includes electrically bypassing the faulty energy storage module and reconfiguring operation controls to operate the vehicle energy storage according to a second configuration that accounts for the electrically bypassed faulty energy storage module. Finally operation of the vehicle energy storage is resumed according to the second configuration.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates drive components of hybrid electric vehicle in a series configuration;

FIG. 2 illustrates a hybrid electric vehicle in a series configuration having a modular energy storage system;

FIG. 3 is a schematic diagram illustrating an embodiment of a dynamically reconfigurable vehicle energy storage system specially adapted for vehicle energy storage of a hybrid electric vehicle;

FIG. 4 is a schematic diagram illustrating an embodiment of a dynamically reconfigurable vehicle energy storage system specially adapted for vehicle energy storage of a hybrid electric vehicle wherein one energy storage module is bypassed;

FIG. 5 illustrates a more detailed view of an embodiment of overvoltage protection circuitry within a single energy storage module;

FIG. 6 is a schematic diagram illustrating the basic operation of a controller according to one embodiment of the invention;

FIG. 7 is a schematic diagram illustrating an embodiment of a dynamically reconfigurable vehicle energy storage system specially adapted for vehicle energy storage of a hybrid electric vehicle having additional componentry, and wherein one energy storage module is bypassed;

FIG. 8 illustrates a one configuration of the vehicle energy storage system specially adapted for a hybrid electric vehicle; and,

FIG. 9 illustrates a flow chart of an exemplary method for dynamically reconfiguring a vehicle energy storage of a hybrid electric vehicle.

### DETAILED DESCRIPTION

After reading this description, it will become apparent to one skilled in the art how to implement the invention in various alternative embodiments and alternative applications. Although various embodiments of the present invention are described herein, it is understood that these embodiments are presented by way of example only, and not limitation. As such, this detailed description of various alternative embodiments should not be construed to limit the scope or breadth of the present invention as set forth in the appended claims.

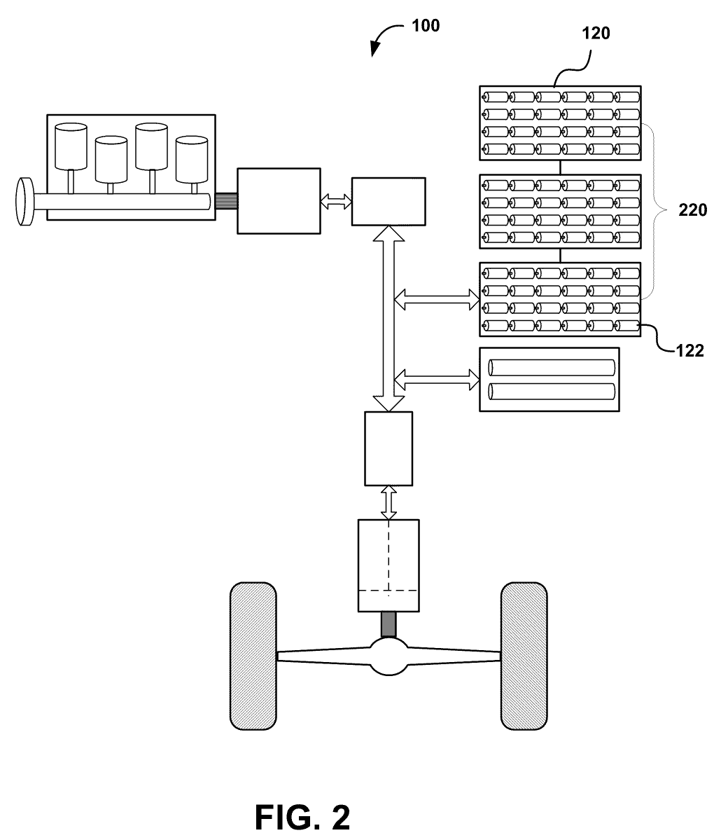

Referring to FIG. 2, in certain heavy duty hybrid applications multiple energy storage packs 120 may be coupled to form a MVES 220. As with single packs, each these multiple packs 120 are made of many individual energy storage cells 122, and the packs 120 may be connected in series, forming a high voltage energy storage system having much higher capacity in the aggregate. In addition to the higher capacity, this modularity provides a benefit of flexibility in the energy storage system's physical layout, standardized parts, and scalability in performance. For example a 500 V energy storage 220 may include two 250 V packs 120 in series, whereas a 750 V energy storage 220 may include three of the same 250 V packs 120 in series.

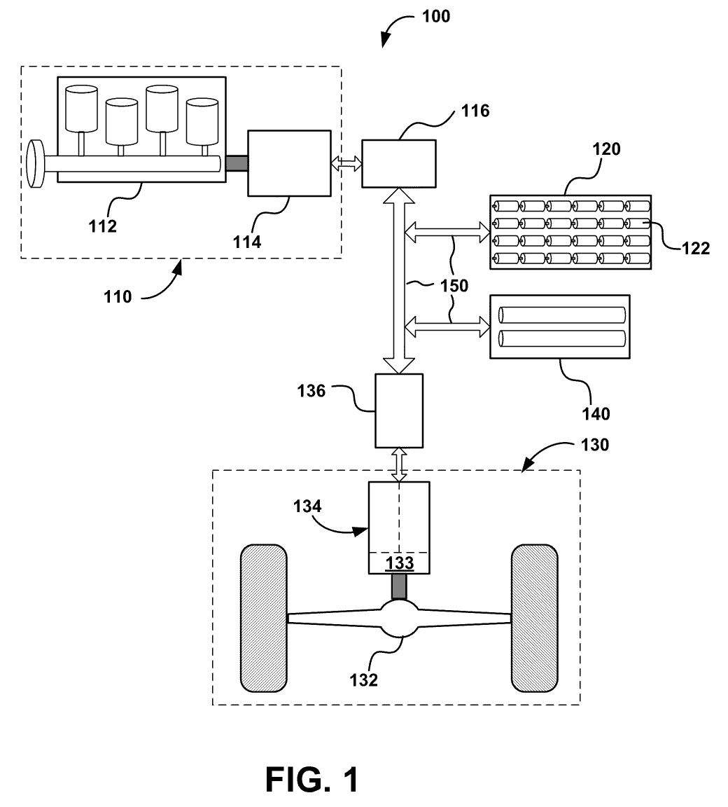

As with the single pack 120 in FIG. 1, in the event one of the multiple packs 120 has one bad cell 122, being a series system, the entire energy storage 220 will be shut down. According to one embodiment, that bad pack may be entirely electrically bypassed from the system. Then the vehicle need not lose the functionality its propulsion energy storage entirely.

However the inventors have discovered, if the entire failed pack 120 (i.e., housing the bad cell 122) were to be electrically bypassed, the entire energy storage might still be damaged. For example, in a Ucap energy storage 220 having 4 packs, if one pack 120 were to be taken offline, the remaining packs would be charged to an overvoltage condition since they no longer have the same capacity. This might then result in a cascade of fault conditions and/or damage to the remaining cells. Thus, whether the failed pack 120 is left alone or bypassed, the condition would ultimately result in the vehicle 100 losing its entire vehicle energy storage 220.

Additionally, given the high power nature of the heavy-duty hybrid, specialized electronic components and procedures would be needed to prevent arcing during high-power switching. This is particularly true in an expanded, higher capacity energy storage 220 having multiple packs 120 and much higher capacity than a single pack. In practice, large contactors are typically used to perform high voltage switching. A contactor is an electromagnetic switching device (a relay) used for remotely switching a power or control circuit. In particular, devices switching more than 15 amperes or in circuits rated more than a few kilowatts are usually called contactors. A contactor is activated by a control input which is a lower voltage/current than that which the contactor is switching. Currently, high voltage contactors are relatively large and expensive, so if they were used to bypass an individual faulty cell 122, the pack 120 would increase significantly in size and cost. Contactors also generate significant heat. Accordingly, bypassing a single failed cell using conventional methods may be impractical—both from an engineering and a financial perspective.

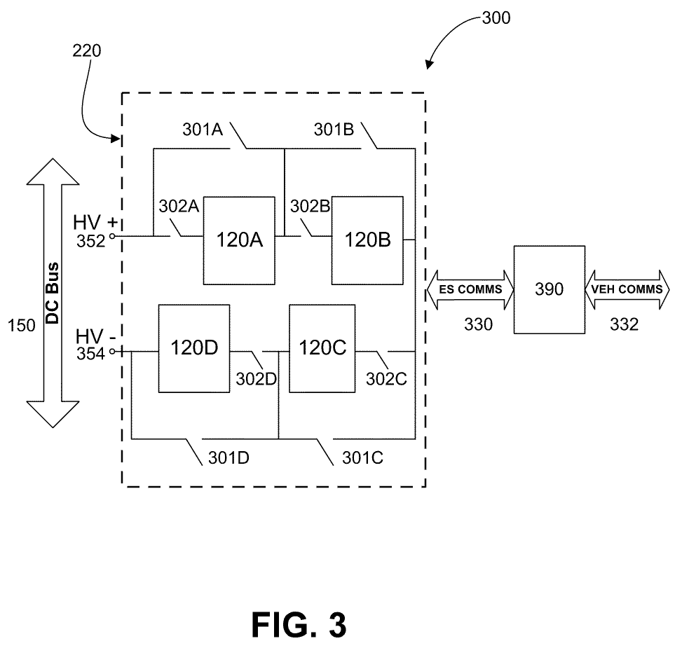

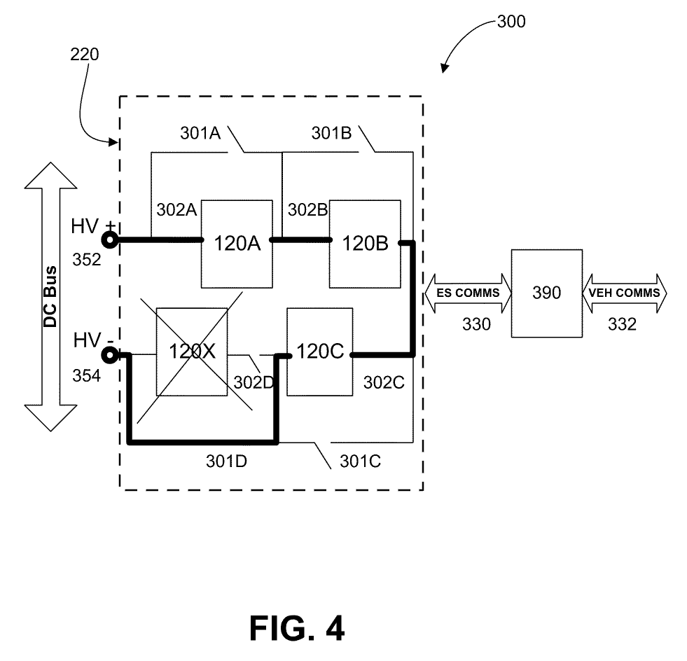

FIG. 3 is a schematic diagram illustrating an embodiment of a dynamically reconfigurable vehicle energy storage system (“ESS”) 300 specially adapted for a hybrid electric vehicle. It is understood that the dynamically reconfigurable ESS may also be implemented in an electric vehicle. The ESS makes use of vehicle drive system operation controls, additional energy storage functionality, and integrated communications. The ESS 300 includes a modular vehicle energy storage 220 (“MVES”) made of a plurality of energy storage modules (“module” or “pack”) 120 configured to store vehicle propulsion energy. The ESS 300 also includes means for detecting a faulty energy storage module 120, and a switch network 301, 302 configured to electrically bypass one or more faulty energy storage modules 120. ESS 300 may also include one or more controllers 390 and a vehicle communication interface 332. Referring to FIG. 4, in operation, ESS 300 may electrically bypass a faulty module 120X.

At the onset, the hybrid electric vehicle is configured to operate the ESS 300 according to an initial or first configuration. Most generally, the initial configuration will reflect a fully-functional vehicle energy storage. This initial configuration may include aspects related to both charging and discharging of the vehicle energy storage.

For example, the drive system 100 may have a set limit on how much current may be safely transmitted to the propulsion energy storage. In particular, where the engine genset 110 is configured to generate electricity until the energy storage is “fully charged”, the generator 114 may be commanded to generate electricity until the DC high power bus 150 reaches a predetermined “fully charged” voltage. “Fully charged” may vary from application to application. In a heavy-duty hybrid electric vehicle the ESS 300 may be rated at 500 VDC. According to one particular embodiment, the ESS 300 of a metropolitan transit bus may be rated at 750 VDC. Thus, according to the initial configuration of said metropolitan transit bus, the vehicle may then command the engine 112 to continue drive its generator 114 until the DC bus 150 has reached 750 VDC.

Also for example, the drive system 100 may have a set limit on how much current may be safely demanded from the ESS 300. This may be particularly true for a battery-based energy storage, which are more sensitive to high current draws and overheating. In particular, the predetermined current limit may be related to the rated power of the vehicle at the rated voltage of a fully-functional energy storage. According to one particular embodiment, the ESS 300 of a metropolitan transit bus may be rated at 300 A. Accordingly, the first configuration may both provide the bus with its required power, while limiting the maximum current from the energy storage.

The initial configuration may include other aspects besides charging and discharging. For example, the vehicle may indicate to its operator an available capacity associated with the energy storage such as max velocity, braking capacity, lifting/climbing power, vehicle acceleration, etc. Also, for example, the vehicle's first configuration may interrelate various subsystems (e.g., fire suppression, cooling, braking, engine optimization algorithms, etc.) such that measured parameters of the ESS 300 are used to set thresholds, triggers, set or reference points, and reporting criteria.

According to one exemplary embodiment, the MVES 220 includes a plurality of energy storage modules (or “packs”) 120A, 120B, 120C, 120D electrically coupled to each other, preferably in series. It is understood that four energy storage modules are shown here for illustration purposes only, and that the vehicle's specific requirements will be used to determine the actual number of packs 120 used. Modular vehicle energy storage 220 electrically interfaces with the vehicle and its drive system 100 via high voltage DC terminals 352, 354. Through high voltage DC terminals 352, 354, high voltage (e.g., over 500 VDC) propulsion energy may be stored in the modular vehicle energy storage 220 or delivered to the electric drive motors 134 to propel the vehicle. Accordingly, current may flow bidirectionally between the vehicle energy storage 220 and the rest of the hybrid electric vehicle drive system 100.

In composition, each energy module 120 includes a plurality of energy storage cells 122. The energy storage cells 122 of the energy storage modules 220 may be battery-based, ultracapacitor-based or the like. Ultracapacitors (or supercapacitors) are a relatively new type of energy storage device that can be used in electric and hybrid-electric vehicles, either to replace or to supplement conventional chemical batteries. Ultracapacitors are electrochemical capacitors that have an unusually high energy density when compared to common capacitors, typically on the order of thousands of times greater than a high-capacity electrolytic capacitor. For instance, a typical D-cell sized electrolytic capacitor will have a storage capacity measured in microfarads, while the same size electric double-layer capacitor would store several farads, an improvement of about four orders of magnitude in capacitance, but usually at a lower working voltage. Larger commercial electric double-layer capacitors have capacities as high as 5,000 farads. Moreover, Ultracapacitors can store and release large amounts of power very rapidly, making them ideal for absorbing the electrical energy produced by electric and hybrid-electric vehicles during regenerative braking. This process may recapture up to 25% of the electrical energy used by such vehicles.

Preferably, each energy storage module 120A-D is its own self-contained unit. One benefit of this would be that a faulty pack 120X could readily be removed and replaced on the vehicle, without disturbing the rest of the energy storage system 300. Each module 120A-D may include a housing that supports and encloses the plurality of energy storage cells 122. The energy storage module may further include at least one interface configured to pass electrical current, communications, and/or cooling across the housing. A wireless link may be used to communicate measured parameters, fault conditions, and command signaling. However, the electrical current should be passed across the housing using an electrically isolated terminal 552, 554. The housing may also include mounting devices such that the module may be mounted directly to the vehicle or to an intermediate bracket assembly. The housing may also include mating devices such that one module can be coupled to another module. Each energy storage module should include sufficient control to be operated independently as the vehicle's only propulsion energy storage. This will allow the energy storage system 300 to be operated down to the last module and also supports a fully scalable vehicle energy storage 220.

According to one embodiment, the ESS 300 and/or each energy storage pack may include, or interface with, an energy storage communication link 330. Energy storage communication link 330 provides for communications with one or more of the modules 120A-D. For example, each module 120 may include a module communication bus 330 internal to the module 120. Alternately, a module communication bus 330 may be integrated with several modules 120A/120B/120C/120D as an independent internal bus, interfaced to a common bus with the other packs, or as a fully integrated communications link integrated with all the packs. Module communication bus 330 provides for energy storage communications within the pack 120, between multiple packs 120A/120B/120C/120D, and/or between one or more packs and another vehicle component.

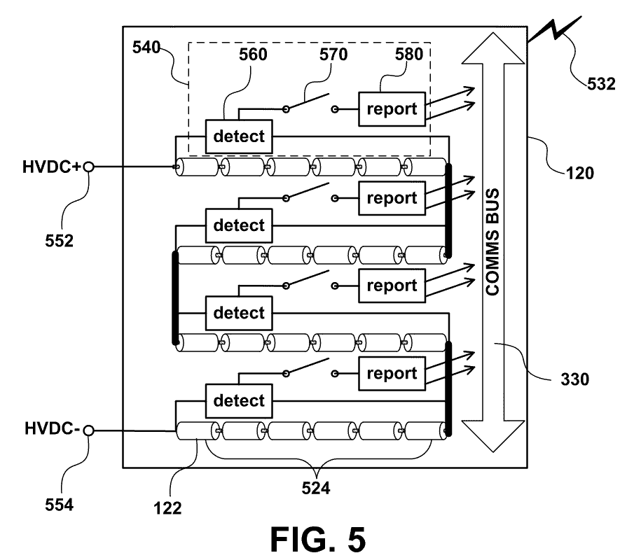

The ESS 300 also includes a fault detector configured to detect a fault condition of one or more energy storage modules 120, or other means for detecting a faulty energy storage module 120. This may include detection circuitry internal to the module 120 and a communication link such as a module communication bus 330. The fault detector can be configured to monitor, acquire, and/or measure one or more measurement parameters of the plurality of modules 120A-D or one or more energy storage cells 122. For examples of fault detection means or overvoltage protection circuitry, see FIG. 5 and also see U.S. patent application Ser. No. 12/237,529 filed Sep. 25, 2008 and U.S. patent application Ser. No. 12/414,275 filed Mar. 30, 2009, which is hereinafter incorporated by reference. Some examples of a fault detector include: an overvoltage protection circuit, cell protection circuit, a voltage measurement circuit, a balancing circuit, a current measurement circuit, or the like.

The fault detector may detect a fault using measurement parameters associated with the energy storage. Some examples of the measurement parameters include: equivalent series resistance (ESR), voltage values, current values, charge value, charge rate, cell charge over time, time to reach maximum voltage, rate of change of voltage, capacitance, lower charge voltage, upper charge voltage, set time out for charging each energy storage module or one or more cells of the energy storage module of the energy storage modules, capacitance, lower charge voltage, upper charge voltage, set time out for charging each energy storage module or one or more cells of the energy storage modules, applied charge, cell voltage, charge time, temperature values, etc.

The fault detector can be electrically coupled to each energy storage cell 122, one or more cells of the module 120, and/or the entire module 120. Accordingly, the fault detector can be configured to acquire, monitor or measure: the measurement parameters of one or more cells 122 of the module 120, the measurement parameters of one or more strings comprising a subset of the plurality of energy storage cells 122, the measurement parameters of at least one energy storage module 120, and/or the measurement parameters of the entire ESS 300 of the hybrid electric vehicle.

In some embodiments, the fault detector can be implemented in conjunction with the module communication bus 330 for communicating the measurement parameters to a controller 390, such as a module controller and/or a system controller. Accordingly, the controller can be incorporated into the energy storage module 120, or may be independent of, but communicatively coupled to the energy storage module 120.

The fault detector may also be also be implemented as a distributed system where discrete components communicate in a coordinated manner. In some embodiments, the fault detector may be incorporated into a module controller or may be independent of, but coupled to, the module controller(s). In other embodiments, the fault detector may be implemented into an integrated circuit (IC) associated with the module controller(s).

FIG. 5, illustrates a more detailed view of one embodiment of overvoltage protection circuitry. Here, the overvoltage protection circuitry is distributed within an individual energy storage module 120. As illustrated, energy storage module 120 may include several energy storage cells 122 electrically coupled together in series forming strings 524. Energy storage module 120 may also include a module communication bus 330, a communication interface 532 for communications out of the module (which may be independent of or integrated with module communication bus 330), a “positive” high voltage DC terminal 552 electrically coupled to the “high” side of the plurality of energy storage cells 122, and a “negative” high voltage DC terminal 554 electrically coupled to the “low” side of the plurality of energy storage cells 122. In addition, multiple energy storage packs 120 may be coupled together using their high voltage DC terminals 552, 554.

As illustrated, each string 524 may include its own overvoltage protection circuitry 540. For example, within vehicle energy storage module 120, the plurality of energy storage cells 122 are shown conveniently grouped in strings 524 of six energy storage cells 122 wherein each string 524 has its own overvoltage protection circuit 540. The overvoltage protection circuit (or “fault detector”) 540 is configured to detect one or more faulty energy storage cells 122. Here, according to one exemplary embodiment, overvoltage protection circuitry 540 may report faults detected within the pack 120 by using detection circuitry 560, on/off circuitry 570, and reporting circuitry 580. Reporting circuitry may be communicably coupled to communication bus 330. As discussed above, communication bus 330 may be internal to the module 120 or maybe implemented as a multiple-module communication bus 330 servicing multiple modules and providing for communication of the multiple modules to a central controller 390. In operation, the overvoltage protection circuitry 540 will detect an overvoltage condition (or other fault condition), trigger an on/off device, and report the overvoltage condition to the vehicle as described in greater detail in the above referenced related applications.

Referring back to FIG. 3, the ESS 300 includes a switch network that is configured to electrically bypass one or more faulty energy storage modules 120A-D. The switch network may include a plurality of switches 301A, 301B, 301C, 301D and 302A, 302B, 302C, 302D. According to one embodiment, switches 302A-D are interspersed in series with modules 120A-D, and are configured to transmit power between adjacent modules. Switches 301A-D run in parallel with modules 120A-D, and are configured to electrically bypass its associated module.

In general, the switches 302A to 302D are closed and the switches 301A to 301D are open during normal operation. In particular, under normal charging operation the one or more energy storage modules 120A to 120D receive charge from a charge source. If none of the one or more energy storage modules 120A-D are faulty, a signal is generated to open the switches 301A to 301D and to close the switches 302A to 302D. In general, the switches 301A to 301D in conjunction with switches 302A to 302D are configured to provide a bypass path and/or a charge path for the energy storage modules 120A to 120D.

As discussed above, the voltages associated with vehicle propulsion may be very high (e.g., over 200 V for automobiles, and on the order of 600 V-800 V for heavy duty vehicles). These high voltages, and associated powers, create challenges for the switching network, and conventional dipole switches may have undesirable performance. Preferably, the plurality of switches 301A to 301D and 302A to 302D are selected from insulated gate bipolar transistors (IGBT), contactors, solid state switches, and/or relays, as these devices have increased reliability and performance compared to other traditional switches.

According to one embodiment, the plurality of switches 301A-D and 302A-D can be implemented within the one or more energy storage modules 120A-D. In other embodiments, at least some of the plurality of switches 301A-D and 302A-D are implemented within the one or more energy storage modules 120A-D, and at least some are independent of the one or more energy storage modules 120A-D. In some embodiments, the switch network may be independent from all of the one or more energy storage modules 120A to 120D. Similarly, in some embodiments, the switch network may be independent of the entire modular vehicle energy storage 220.

The ESS 300 also includes a controller 390 configured to determine a faulty energy storage module, to determine that current flow between the vehicle energy storage and the hybrid electric vehicle is below a minimum threshold, to reconfigure operation controls to operate the vehicle energy storage according to a second configuration that accounts for the electrically bypassed faulty energy storage module, and to resume operation of the vehicle energy storage according to the second configuration. Controller 390 may include a communications link 330 to the vehicle energy storage 220 as well as a vehicle communication link 332 to the vehicle. Controller 390 may be embodied as a single controller or multiple controllers. Moreover, certain functionality may reside in controller 390 whereas other functionality described herein may be provided by another device. Accordingly, controller 390 is illustrated as a single device for clarity rather than as a limitation.

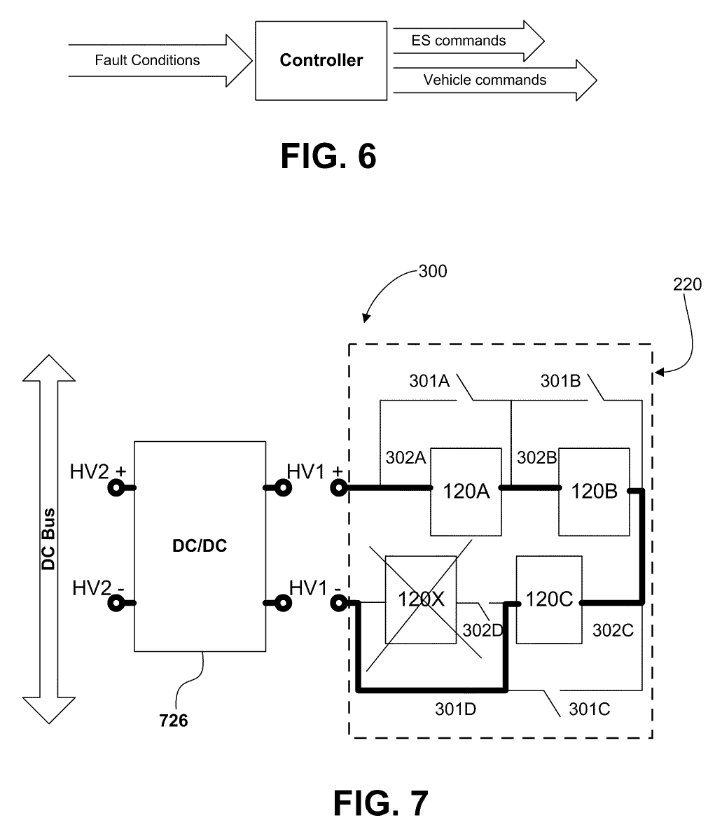

FIG. 6 is a schematic diagram illustrating the basic functionality of the controller 390 according to one embodiment of the invention. As illustrated, controller 390 receives fault conditions from the fault detector and outputs a combination of energy storage commands and/or vehicle commands. Energy storage commands may generally relate to switching, and vehicle commands may generally relate to stopping operation of the energy storage modules 220 and to reconfiguring the vehicle. The fault conditions may be received as a predetermination that a module 120X is faulty. In the alternate, fault conditions may be received merely as raw measurement parameters, which are then processed in controller 390 to make the determination that module 120X is faulty. It is understood that 120X may be determined to be “faulty”, for example, by virtue of a single bad cell 122, a condition of the pack (e.g., overtemperature), or any other predetermined failure criteria.

Preferably, the controller will command the switch network to electrically bypass faulty module 120X. At least some or all of the plurality of switches 301A-D and switches 302A-D can also be associated with or controlled by the one or more controllers 390. Thus, controller 390 operates the switch network such that one or more faulty energy storage packs 120X are safely taken off-line. In particular, and for example in FIG. 4, the controller 390 sends a signal to disconnect or open switch 302D and connect or close switch 301D, so that, here, the charge current bypasses the energy storage module 120X and continues to/from energy storage module 120C from/to terminal 354 via the path created by the closed switch 301D.

The inventors have discovered that, in certain circumstances (i.e., when the vehicle energy storage 220 is transmitting or receiving energy at voltage) excessive wear and even arching may occur during switching a pack offline. Accordingly, controller 390 will first determine that current flow between the vehicle energy storage modules 220 and the hybrid electric vehicle is below a minimum threshold. For example, upon detecting a faulty pack 120X, controller 390 may wait until current is neither flowing into nor out of the MVES 220 (i.e., during pack charge or discharge).

The minimum threshold may be where the charge/discharge current is negligible or otherwise sufficiently low that opening the circuit will not cause a condition outside of the switch network's normal operation range. The minimum current threshold may also incorporate its power level or profile. For example, the minimum threshold may be set to zero current, less than 5% of the energy storage system's rated current, less than 5% of the energy storage system's rated power transmission, and the like. Some benefits of imposing a minimum current or power threshold include increased reliability and performance, reduced switch wear, and that the switch network may not need to include more specialized and expensive high power switches.

The controller 390 may passively or actively determine the minimum threshold. For example, the controller 390 may passively wait for a “window of opportunity” where the charge/discharge current is negligible or otherwise sufficiently low that opening the circuit will not cause a condition outside of the switch network's normal operation range. For example, controller 390 may directly measure current flow, such as between high voltage terminals 352, 354, to determine when the minimum threshold has been met. Alternately, controller 390 may interpret vehicle control messages communicated over a vehicle communication bus to anticipate a break in current flow, such as a drive system command coming from the brake or accelerator pedal, which could be associated with a transition in the current flow into or out of the ESS 300.

Alternately, the controller 390 may actively determine the minimum current threshold by creating the desired “window of opportunity”, where the charge/discharge current is negligible or otherwise sufficiently low. For example, where the drive system 100 is charging the ESS 300, controller 390 may issue a command to cease the generation electricity. Also for example, controller 390 may temporarily inhibit the engine generator 114 or the wheel motor(s) 134 (operating as a generator) from transferring energy to the energy storage. This may be accomplished by shutting down the generator and/or diverting its charge.

Electricity generation may be shut down directly, for example, by shutting down the engine 112 (or fuel cell if so equipped) or by switching the generator off. Generation may be shut down indirectly, for example, by activating an Idle-Stop algorithm (or the like). Where the electricity is generated via braking regeneration, braking resistors 140 may be brought online in advance to avoid an interruption or loss in regenerative vehicle braking.

Alternately, where the drive system 100 is charging the ESS 300, generated charge may be diverted to other electric loads and/or dissipated such as through the braking resistors 140. In this way, the generated charge does not reach the MVES 220. Likewise, where the drive system 100 is discharging the MVES 220, Controller 390 may issue a command cease the demand for power and/or remove the load across the energy storage. According to one embodiment, controller 390 may first passively wait for the minimum threshold to occur for a predetermined time, after which, the controller 390 may actively command the minimum threshold to occur.

The controller 390 may also temporarily inhibit operation of the vehicle energy storage or inhibit a demand for power before and/or during operation of the switch network and/or the reconfiguration. In particular, upon detection of one or more faulty energy storage modules 120A-D the one or more controllers 390 temporarily disconnect operation of ESS 300, including disconnecting the charging of the one or more energy storage modules 120A-D by a charge source. Information to temporarily disconnect operation of the vehicle energy storage may be communicated via the energy storage communication link 330. Thus the controller 390 may terminate a demand for power from the ESS 300 to temporarily inhibit operation of the vehicle energy storage system until resuming operation of the ESS 300 according to the second configuration. This particularly beneficial where contactors are used to electrically couple the MVES 220, and/or where the individual energy storage modules 120A-D and are controlled locally.

Controller 390 may also be configured to reconfigure the vehicle (directly or indirectly) to operate according to a second configuration that accounts for the electrically bypassed faulty energy storage module. The second configuration may include various vehicle parameter changes. For example, the second configuration may include changes to energy storage charging, discharging, vehicle power rating, vehicle power limits, vehicle braking capacity, ancillary control software that depends upon the ratings of the energy storage, etc.

To aid in understanding the second configuration, an example is made of a modification to an exemplary vehicle's operation controls pertaining to energy storage charging. In particular, an 800 VDC MVES 220 may have four energy storage packs 120A, 120B, 120C, 120D, each rated at 200 VDC, coupled in series with each other and the high voltage DC bus 150.

According to this example, during normal operation, the generator 114 will normally charge the exemplary high voltage DC bus 150 to a full charge of 800 VDC before shutting down (i.e., the first configuration). However, following a fault in one pack, only three packs 120 are left online (the fourth being electrically bypassed). Charging the DC bus 150 according to the first configuration could result in the DC bus being charged to 800 VDC and thus an overvoltage condition. For example, the above 200 VDC pack 120 may have 75 cells 122, rated at 2.7 VDC each. Once the failed pack is taken offline, charging the DC bus 150 up to 800 VDC may result in each cell having an average 3.3 VCD across, or 22% over the spec max. Accordingly, this will place an out-of-spec voltage across the cells, and may prematurely wear and/or damage one or more cells 122.

As such, following a module fault, the controller 390 may reconfigure the heavy duty hybrid to only charge the DC bus to 600 VDC. Thus, once the DC bus 150 reaches 600 VDC, the vehicle's operation controls may be commanded to shut down the engine 112 or generator 114. According to this exemplary embodiment, the limitation on the vehicle controls to only charge to 600 VDC would represent the second configuration to which the hybrid electric vehicle has been reconfigured to operate its energy storage at.

In reconfiguring the vehicle, the controller 390 may communicate with a plurality of components onboard the vehicle. These components may be within the ESS 300 or elsewhere in the vehicle. In communicating with the plurality of components, controller 390 may utilize one or more vehicle communication networks (e.g., a controller area network “CAN”). For example, according to one embodiment, controller 390 may communicate with the ESS 300 via a dedicated “energy storage CAN bus”, to the drive system 100 via a dedicated “drive system CAN bus”, and to a driver interface via a “vehicle CAN bus”.

FIG. 7, is a schematic diagram illustrating an embodiment of a dynamically reconfigurable vehicle energy storage system specially adapted for vehicle energy storage of a hybrid electric vehicle having additional componentry, and wherein one energy storage module is bypassed. As illustrated, in some embodiments, the hybrid-electric drive system 100 includes a converter, such as a DC/DC converter 726, coupled to the MVES 220 and configured to convert the energy from one voltage level to another. In particular, DC/DC converter 726 may be configured to boost energy leaving vehicle energy storage from a first voltage HV1 to a higher voltage HV2. For example the one or more controllers 390, may be configured to control the converter 726 to provide output voltage as required by a drive system of the hybrid electric vehicle. In particular, converter 726 may boost the diminished voltage of the reconfigured ESS 300 back up to the operational voltage of motor 134. This may be particularly valuable as the cumulative voltage available from a vehicle energy storage 220 having one or more “bypassed” faulty modules 120X may fall below the operational voltage of one or more electric motors (e.g., electric motor(s) 134), despite the individual energy storage cells 122 still holding substantial charge. This is especially true where the ESS 300 is battery based since batteries are more sensitive to deep discharge.

Alternately, when a faulty energy storage module 120X is detected and bypassed, the energy required to charge the remaining energy storage modules 120A-C is reduced. Accordingly, the one or more controller 390 reconfigures the converter to buck the source of charge (i.e., generator 114 or motor 134 in regen) down to a lower voltage, which is associated with the bypassed energy storage module(s) 120X.

In other embodiments, the ESS 300 includes a boost assembly DC/DC converter 726 that comprises a high-power inductor and a high power, controllable switch, such as an IGBT. The boost assembly 726 can be implemented within the energy storage system 300 or can be independent but electrically coupled to ESS 300 to boost output voltage of the vehicle energy storage 220 when the output voltage falls below a threshold level due to bypassing the faulty energy storage module 120X, for example. Preferably the high-power inductor will be at least rated as high as the vehicle energy storage 220. For example the high-power inductor may have a rated DC voltage of 650 VDC and a peak current of 300. The high-power inductor may include the cooled inductor of patent application Ser. No. 12/013,211 filed Jan. 11, 2008, which is hereinafter incorporated by reference. According to one embodiment, the high power switches of converter 726 may also be used to temporarily disconnect operation of the vehicle energy storage 220 and provide the minimum threshold condition needed to operate the switch network.

According to one embodiment, the high power controllable switch may be one phase of a multi-phase inverter electrically coupled to the vehicle energy storage. For example, in hybrid electric drive system 100 inverters 116 and 136 may integrated in an eight phase inverter, such a Siemens High Frequency IGBT 8 Phases DUO-inverter. As such, three channels/phases may be used for 3-phase AC from/to the generator 114 to the DC bus 150, three channels/phases can be used for 3-phase AC to/from the electric motor(s) 134, and one of the two remaining “free” channels/phases may be separately controlled to operate as the high power, controllable switch of DC/DC converter 726. In some embodiments, the high power inductor of DC/DC converter 726 is a high power inductor in series with and in between the MVES 220 and the “free” phase of the multi-phase inverter. In this way, controls already available with the inverter may also be used to boost the diminished voltage of the reconfigured MVES 220.

According to one alternate embodiment, the controller 390 generates an alert or message in response to a faulty energy storage module 120X. The message or alert can be communicated to the vehicle, the operator, and/or a remote party. According to one embodiment, the message or alert is communicated via a vehicle communication bus such as a vehicle controller area network (CAN) bus. The message or alert can be displayed on a user interface on the vehicle or forwarded to an administrator via vehicle telemetry equipment or otherwise. The message may include a real-time message, for example, informing the hybrid electric vehicle or the operator not to pull power from the ESS 300 (e.g., not to accelerate, not to operate in EV-mode, etc.) until the faulty energy storage module 120X is safely bypassed. The message may also record an electronic message, for example, informing a maintenance facility or transit agency of the fault. The recorded message may be communicated via email, text message, and/or other conventional means.

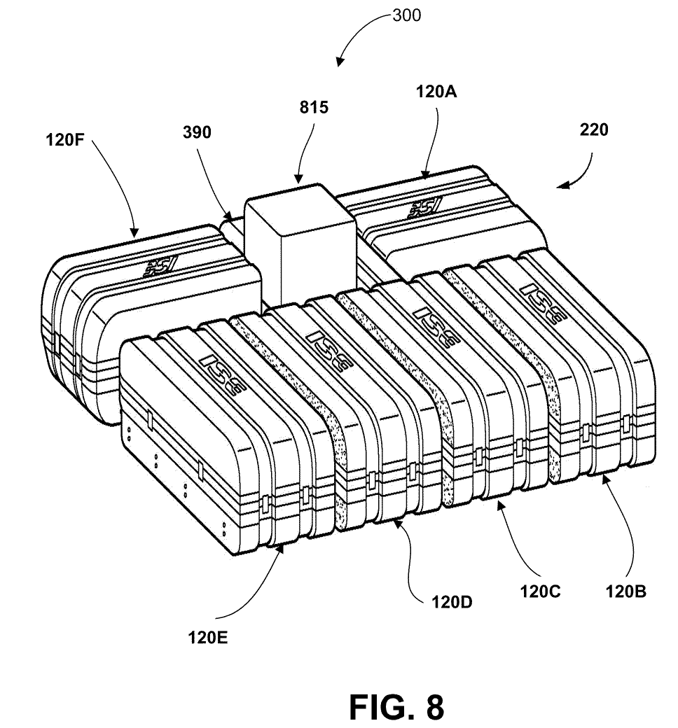

FIG. 8 illustrates a one configuration of the vehicle energy storage system specially adapted for a hybrid electric vehicle. In particular, here six energy storage modules 120A-F are shown as individual self-contained packs. Since energy storage 220 is in modular form, a vehicle integrator will have much greater flexibility in conforming the ESS 300 to the form or dimensional envelope of the vehicle.

As discussed above, heavy duty hybrids have such high electrical power demands that cooling may become necessary. Here, ESS 300 is also illustrated including a central water chiller 815 or cooling supply for cooling ultracapacitors of the energy storage modules 120A-F. As such, each module 120A-F may include its own dedicated heat exchanger wherein chiller 815 provides a central coolant source

In some embodiments, each of the plurality of energy storage modules 120A-F may include 48 ultracapacitors laid out in a single layer 6×8 array, oriented so that the longitudinal axis of each ultracapacitor is vertically oriented with reference to the vehicle. This configuration, along with the compact nature of each of the plurality of energy storage modules 120A-F, provides for low profile, modular energy storage modules 120A-F that can be arranged in a variety of different configurations and numbers to provide the desired energy storage for the particular application. In other applications, different configurations, arrangements/orientations, and/or numbers of energy storage modules may be provided. Also, here controller 390 is illustrated as a stand-alone unit.

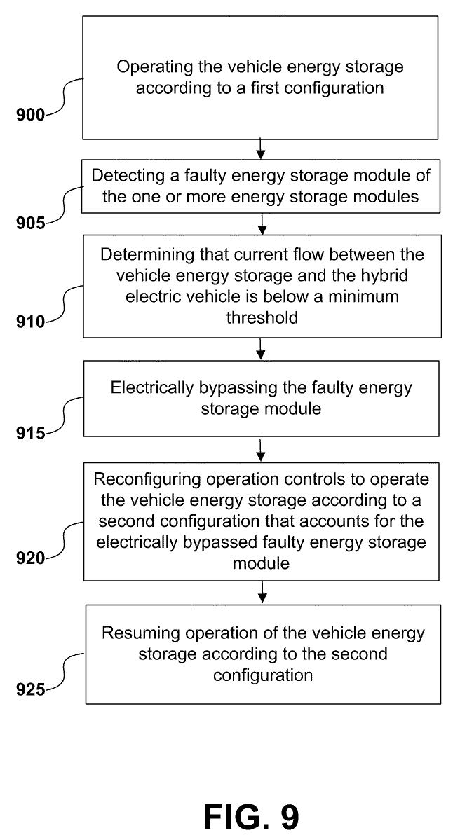

FIG. 9 is a flow chart of an exemplary method for dynamically reconfiguring a vehicle energy storage of a hybrid electric vehicle by electrically bypassing one or more energy storage modules 120 within an energy storage system 300 of the hybrid electric vehicle. The MVES 220 includes one or more energy storage modules 120A-D, each having a plurality of energy storage cells 122. The ESS 300 is configured to store vehicle propulsion energy. The method may be implemented, for example, in a modular ESS 300 such as illustrated in FIGS. 2-8. Moreover, the method may be performed as discussed above.

At block 900 the process starts with operating the ESS 300 according to a first configuration. This will generally correspond to a fully-functional energy storage system. However, the first configuration may, in some instances, already include one or more faulty packs. Operating the ESS 300 according to the first configuration may include charging and/or discharging the ESS 300.

The process then continues to block 905 where a faulty energy storage module is detected. For example, faulty energy storage module 120X may be one of the one or more energy storage modules 120A-D discussed above. Similarly, the faulty energy storage 120X may be detected using the fault detector described above.

At block 910, the method includes determining that current flow between the vehicle energy storage and the hybrid electric vehicle is below a minimum threshold. As discussed above the minimum threshold will vary from application to application, but preferably will be associated with the performance rating of the switching network. The flow minimum threshold may be determined passively or active caused.

In some embodiments, the method may actively create a “window of opportunity”, where the current flow between the ESS 300 and the hybrid electric drive system 100 is below a minimum threshold, as discussed above. According to one embodiment, the system, for example via a controller, may temporarily inhibit operation of the vehicle energy storage until the resuming operation of the vehicle energy storage. For example, temporarily inhibiting operation of the vehicle energy storage can include shutting down a generator or terminating a demand for power on the vehicle energy storage. Additionally, the inhibition may include disconnecting the charging of the one or more energy storage modules 120A-D by the charge source.

At block 915 the faulty energy storage module 120X is electrically bypassed. This may be accomplished with the switching network described above. A module may be electrically bypassed by opening the electrical path between the faulty energy storage module 120X and the rest of the modular vehicle energy storage 220, and forming an alternate electrical path around the faulty energy storage module 120X.

The method then continues to block 920 where the operation controls to operate the MVES 220 or ESS 300 are reconfigured according to a second configuration that accounts for the electrically bypassed faulty energy storage module 120X. The operation controls may include parameters set in an engine control unit (ECU), an electric vehicle control unit (EVCU), a drive interface controller, an energy storage control module, etc., and any combination thereof. As discussed above the reconfiguration will generally include lowering performance parameters and set points to reflect the diminished energy storage capacity.

Finally at block 925 operation of the ESS 300 is resumed according to the second configuration. According to one embodiment, the resuming operation of the ESS 300 according to the second configuration may include discharging the MVES 220 in response to a demand, followed by boosting the energy transferred from the vehicle energy storage 220 to the hybrid electric vehicle from one voltage level to another based on the electrically bypassing of the faulty energy storage module 120X. An inductor-based boost converter may be used to boost the voltage of the electricity on the DC bus 150 available from the reconfigured energy storage system 300.

In other implementations, the resuming operation of the ESS 300 according to the second configuration may include charging the vehicle energy storage system with either the engine gen set 110 and/or the electric motor(s) 134. In this situation, the method may include limiting charge transferred from the hybrid electric vehicle to the vehicle energy storage. As described above, this may be accomplished, for example, by resetting the charge set point of the DC bus from a first voltage to a lower second voltage based on the reduced capacity associated with the bypassing of the faulty energy storage module. Alternately, the charging may be terminated prematurely and/or redirected to on load demands of the vehicle.

Those of skill will appreciate that the various illustrative logical blocks, modules, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the invention. In addition, the grouping of functions within a module, block or step is for ease of description. Specific functions or steps can be moved from one module or block without departing from the invention.

The various illustrative logical blocks and modules described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art. It is further understood that the scope of the present invention fully encompasses other embodiments and that the scope of the present invention is accordingly limited by nothing other than the appended claims.

1. A vehicle energy storage system specially adapted for a vehicle having an electric drive system, the vehicle configured to operate the vehicle energy storage system according to a first configuration, the vehicle energy storage system comprising:
a vehicle energy storage having a plurality of energy storage modules electrically coupled together, each energy storage module having a plurality of energy storage cells, the vehicle energy storage configured to store vehicle propulsion energy;
a fault detector configured to detect a fault condition of one or more energy storage modules of the vehicle energy storage;
a switch network configured to electrically bypass one or more faulty energy storage modules;
a controller configured to determine a faulty energy storage module, to determine that current flow between the vehicle energy storage and the vehicle is below a minimum threshold, to command the switch network to electrically bypass the faulty energy storage module, to reconfigure the vehicle to operate the system according to a second configuration that accounts for the electrically bypassed faulty energy storage module, and to resume operation of the system according to the second configuration.

2. The system of claim 1, wherein the second configuration includes limiting energy transferred from the vehicle to the vehicle energy storage during charging.

3. The system of claim 1, wherein the controller is further configured to temporarily inhibit operation of the vehicle energy storage until reconfiguring the vehicle to operate the system according to the second configuration.

4. The system of claim 2, wherein inhibiting operation of the vehicle energy storage comprises inhibiting a demand for power from the vehicle energy storage.

5. The system of claim 2, wherein inhibiting operation of the vehicle energy storage comprises inhibiting a generator of the vehicle from transferring energy to the vehicle energy storage.

6. The system of claim 1, wherein the controller is further configured to boost energy transferred from the vehicle energy storage to the vehicle from a first level to a second level that reflects the electrically bypassed faulty energy storage module.

7. The system of claim 6, further comprising:
a high power inductor in series with and in between the vehicle energy storage and the vehicle; and,
a controllable high power switch in series with and in between the vehicle energy storage and the vehicle;
wherein the controller is further configured to operate the controllable high power switch to boost energy transferred from the vehicle energy storage to the vehicle during discharging from a first level to a second level that reflects the electrically bypassed faulty energy storage module.

8. The system of claim 7, wherein the vehicle includes a multi-phase inverter electrically coupled to the vehicle energy storage and one of a vehicle generator and an electric drive motor; and,
wherein the controllable high power switch comprises a single phase of the multi-phase inductor.

9. The system of claim 1, wherein the controller is further configured to communicate a message in response to detecting the faulty energy storage module.

10. A method for dynamically reconfiguring a vehicle energy storage of a vehicle including an electric drive system, the vehicle energy storage including one or more energy storage modules, each having a plurality of energy storage cells, the vehicle energy storage configured to store vehicle propulsion energy, the method comprising:
operating the vehicle energy storage according to a first configuration;
detecting a faulty energy storage module of the one or more energy storage modules;
determining that current flow between the vehicle energy storage and the vehicle is below a minimum threshold;
electrically bypassing the faulty energy storage module;
reconfiguring operation controls to operate the vehicle energy storage according to a second configuration that accounts for the electrically bypassed faulty energy storage module; and
resuming operation of the vehicle energy storage according to the second configuration.

11. The method of claim 10, further comprising temporarily inhibiting operation of the vehicle energy storage until the reconfiguring operation controls to operate the vehicle energy storage according to a second configuration.

12. The method of claim 11, wherein the operating the vehicle energy storage according to a first configuration comprises charging the vehicle energy storage.

13. The method of claim 12, wherein the temporarily inhibiting operation of the vehicle energy storage comprises shutting down at least one of a generator or a regenerating electric motor.

14. The method of claim 11, wherein the operating the vehicle energy storage according to a first configuration comprises discharging the vehicle energy storage.

15. The method of claim 14, wherein the temporarily inhibiting operation of the vehicle energy storage comprises terminating a demand for power from the vehicle energy storage.

16. The method of claim 10, further comprising reconfiguring the vehicle to reflect the electrically bypassed faulty energy storage module.

17. The method of claim 10, wherein the resuming operation of the vehicle energy storage according to the second configuration comprises discharging the vehicle energy storage, the method further comprising boosting energy transferred from the vehicle energy storage to the vehicle from one voltage level to another based on the electrically bypassing the faulty energy storage module.

18. The method of claim 10, wherein the resuming operation of the vehicle energy storage according to the second configuration comprises charging the vehicle energy storage, the method further comprising limiting charge transferred from the vehicle to the vehicle energy storage based on the reduced capacity associated with the bypassing the faulty energy storage module.

19. The method of claim 10, further comprising communicating a message in response to the detecting the faulty energy storage module.

20. The system of claim 1, wherein the vehicle is a hybrid electric vehicle.
